(19) United States
(12) Patent Application Publication
(10) Pub. No.: US 2008/0172571 A1
(43) Pub. Date: Jul. 17, 2008

(54) METHOD AND SYSTEM FOR PROVIDING BACKUP STORAGE CAPACITY IN DISK ARRAY SYSTEMS

(75) Inventors: Shawn C. Andrews, Youngsville, NC (US); Don S. Keener, Apex, NC (US); Thomas H. Newsom, Cary, NC (US); Adam Roberts, Moncure, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 11/622,412

(22) Filed: Jan. 11, 2007

(51) Int. Cl. G06F 11/00

(52) U.S. Cl. 714/6; 714/E11.001

(57) ABSTRACT

A method and system utilizing backup disk drives in disk array systems. In one aspect, a disk array system includes one or more disk arrays, each including two or more disk drives. The system includes a spare disk drive, and a controller operative to assign the spare disk drive to a particular one of the disk arrays having a type different than the type of the spare disk drive in response to a failure of a disk drive of the particular disk array, such that the spare disk drive stores data from and operates in place of the failed disk drive.

### FIELD OF THE INVENTION

The present invention relates to data storage systems for computers, and more particularly to backup data storage disk drives in a disk array system.

### BACKGROUND OF THE INVENTION

Data storage systems are widely used to store and archive data for computer systems. Hard disk drives are one of the most common forms of storage system, allowing long-term data storage, fast input/output for data, and random access to stored data. One common way to provide a highly reliable storage subsystem is to use an array of multiple hard disk drives which collectively provide a much greater storage capacity than any single disk while making access to data immune to the same type of failure that would cause a single drive to lose access. A disk array system collects these multiple physical disk drives into single or multiple logical disks.

A Redundant Array of Inexpensive (or Independent) Disks (RAID) is a common form of disk array subsystem that provides a more reliable storage and greater capacity. A RAID can provide increased storage capacity, as well as increased data integrity, fault-tolerance, and/or data throughput compared to single drives. Typically, multiple hard disks are provided in a chassis and connected to a RAID controller that handles the data storage and retrieval on the multiple drives while providing a connected computer system with desired logical partitions. The combination of drives used together in this fashion is a RAID array. The data stored in the RAID system can be divided onto the various drives in numerous configurations.

RAID subsystems can include one or more spare disk drives, or “hotspares,” which as referred to herein are spare, backup disk drives in the disk array system that are continually powered but are typically unused until a failure occurs in one of the operating disk drives, at which point a hotspare is assigned to the disk array having the failed disk, and the failed disk's data is recreated on the hotspare. The hotspare is used in the array until the failed drive is replaced. At this time one of two events will occur. The replacement drive will be set to an unassigned state if the RAID array does not support copyback. Otherwise the replacement drive will be copied-back to from the in-use hot spare and the hot spare will be returned to the unused state at the completion of this operation.

The disk drives of a RAID subsystem use a standard interface with the RAID controller. One such standard is SAS (serial attached SCSI (Small Computer System Interface)). Another standard used under SAS is SATA (serial ATA (Advanced Technology Attachment)). SAS disk drives are more expensive than SATA disk drives but perform random IO better than SATA drives and are more reliable. In SAS subsystems, both SAS and SATA drives can be intermixed, but the SAS and SATA drives are not allowed to be mixed within a single RAID array, nor are hotspares of one type allowed to be used with another. This is due to the fact that the drive technologies have different performance attributes and reliability characteristics. The more serious problem would be the failure rate exposure caused by the higher failure rate of the SATA drive to having a second failure of the array while in the degraded state. For example, a SAS RAID 5 array that allowed long term incorporation of a SATA hotspare would potentially be subject to a second failure before the original failed SAS drive could be replaced.

However, there may be instances where a failure occurs in a disk of a SAS array, no SAS hotspares are available. The system would then cause the SAS array to operate in “degraded mode,” in which a failed drive's data is reconstructed from the other disks in the array and stored on these other disks. Degraded mode operation takes longer and is more processor-intensive, and is very vulnerable, since if another drive fails, there will be loss of data. This degraded mode would be entered even if a SATA hotspare drive is unused and available. Thus, in some cases, the performance exposure when using the SATA drive in the SAS array would be far less than the performance exposure of running in degraded mode. However, there is currently no option for users to use a disk drive as a temporary hotspare in an array of a different technology type.

Accordingly, what is needed is a selective ability to maximize data protection in a disk array system using disk drives of different types, without allowing indiscriminate long-term mixing of the disk drive technologies and the associated problems with such a configuration. The present invention addresses such a need.

### SUMMARY OF THE INVENTION

The invention of the present application relates to backup data storage disk drives in a disk array system. In one aspect of the invention, a disk array system includes one or more disk arrays, the disk arrays each including two or more disk drives. The system includes a spare disk drive, and a controller operative to assign the spare disk drive to a particular one of the disk arrays having a type different than a type of the spare disk drive in response to a failure of a disk drive of the particular disk array, such that the spare disk drive stores data from and operates in place of the failed disk drive.

In another aspect of the invention, a method for utilizing a backup disk drive in a disk array system includes detecting a failure of a disk drive in a disk array of the disk array system A spare disk drive is assigned to the disk array having the failed disk drive, where the spare disk drive is of a different type than the particular disk array, and where the spare disk drive stores data from and operates in place of the failed disk drive. A similar aspect of the invention is provided for a computer readable medium including program instructions for implementing similar features.

The present invention provides a method and apparatus allowing maximum data protection and less expense in a disk array system by using a spare disk with a disk array of a different type. The invention also alerts the user as to any compromised operating conditions of the disk array resulting from the mixing of drive types, and promotes the remedying of such conditions as quickly as possible.

### BRIEF DESCRIPTION OF THE FIGS.

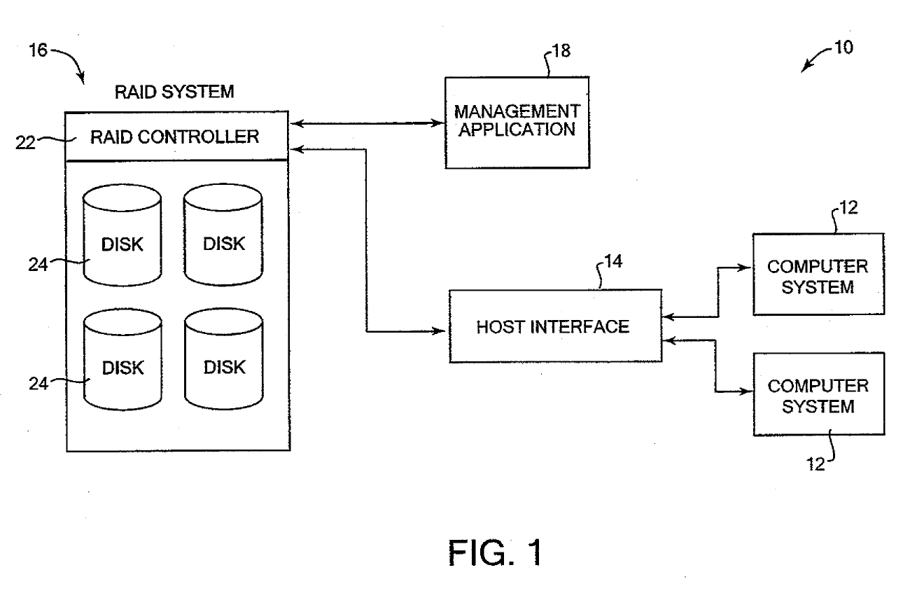

FIG. 1 is a block diagram illustrating a system suitable for use with the present invention;

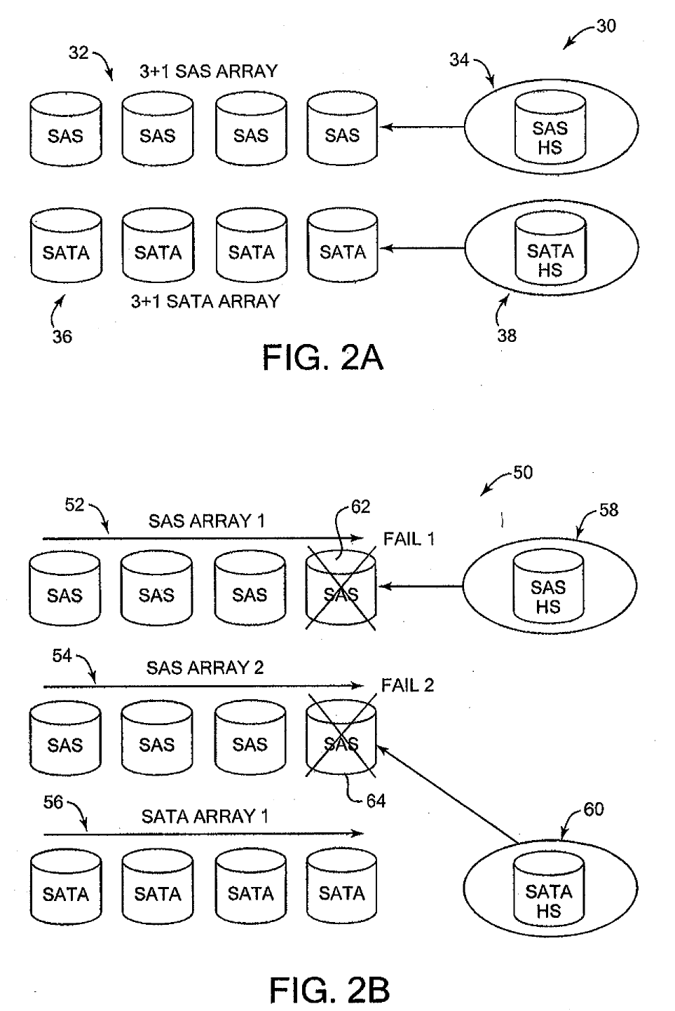

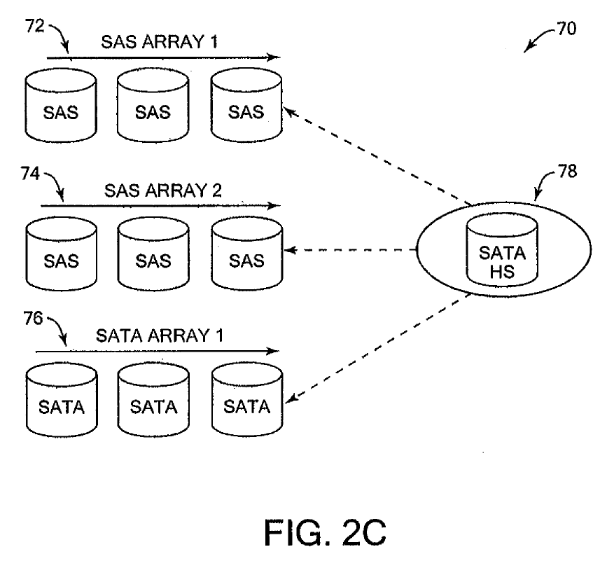

FIGS. 2A-2C are diagrammatic illustrations showing examples of disk array systems suitable for use with the present invention;

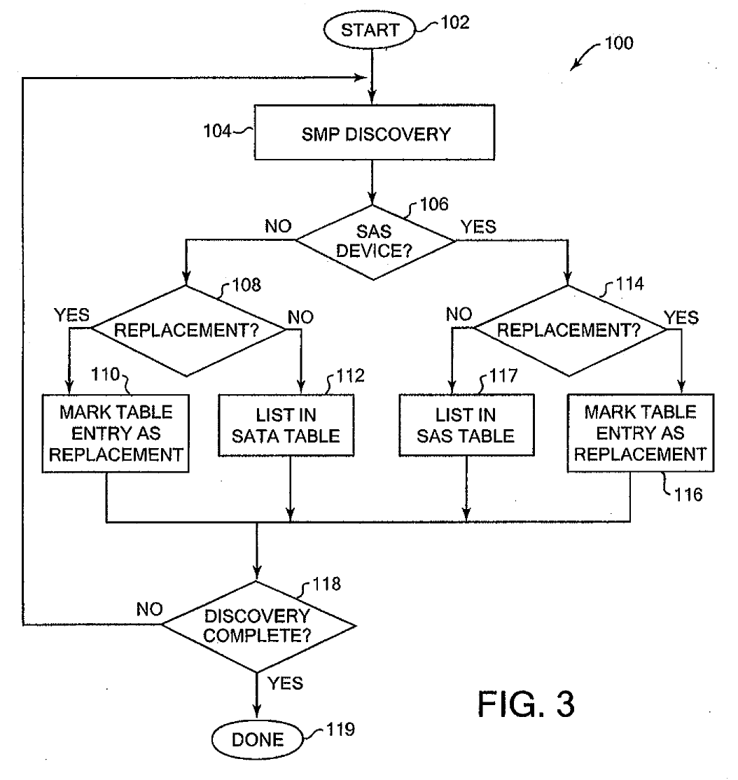

FIG. 3 is a flow diagram illustrating a method of the present invention for detecting drives and drive types in a disk array system;

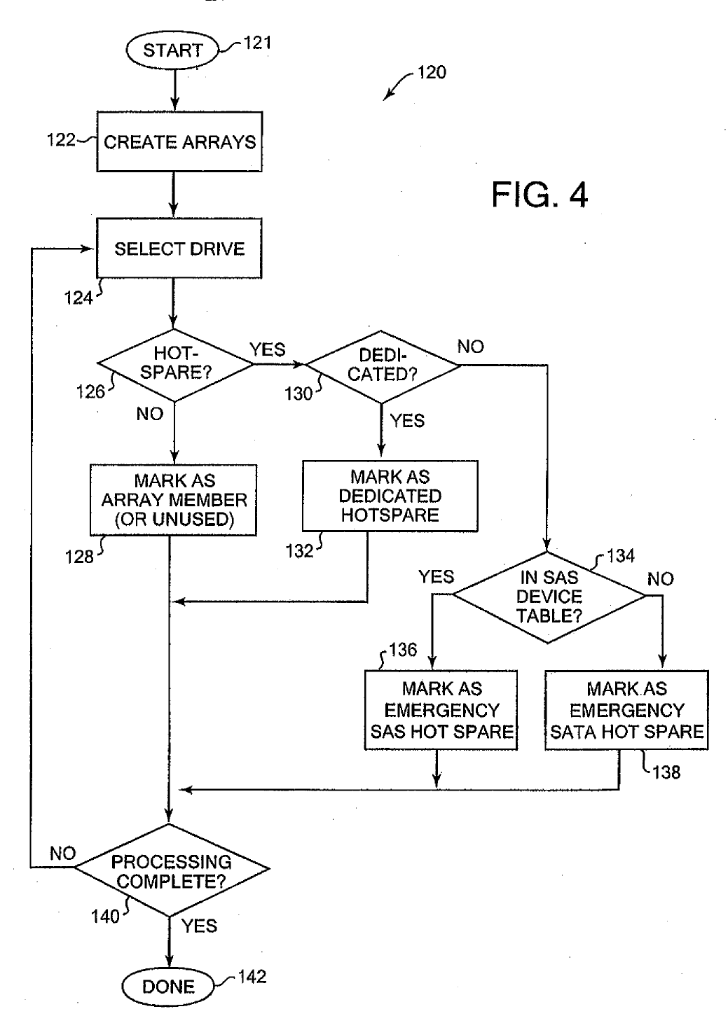

FIG. 4 is a flow diagram illustrating a method of the present invention for categorizing array and hotspare drives in a disk array system;

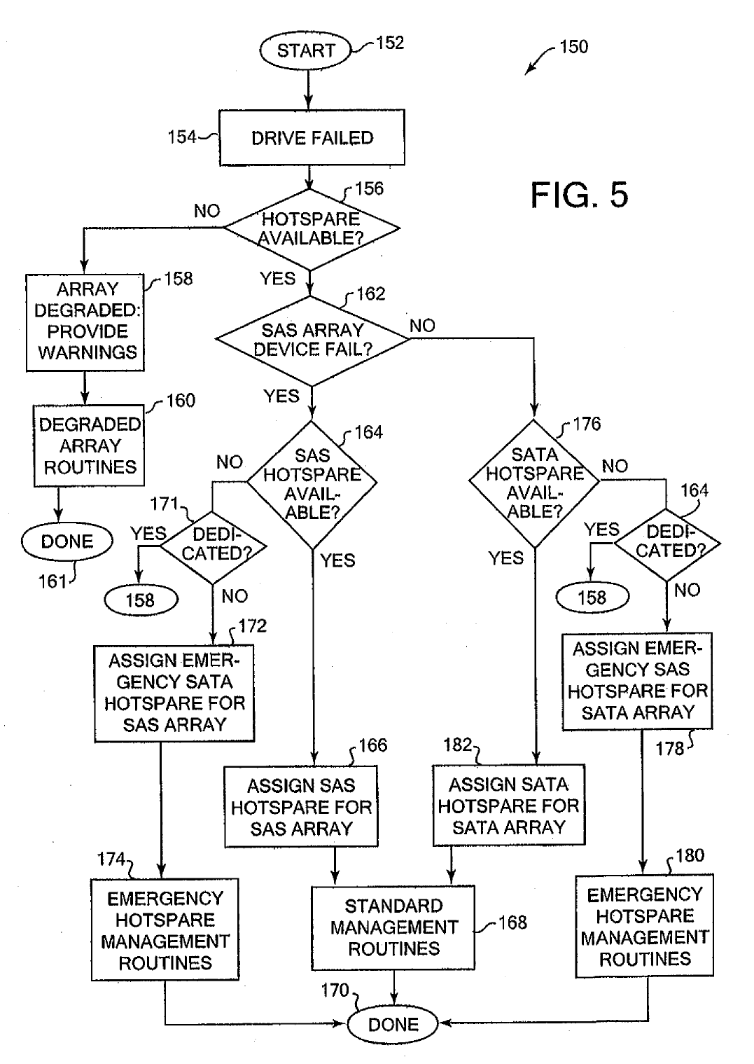

FIG. 5 is a flow diagram illustrating a method of the present invention for determining whether hotspares are available after a disk drive failure has occurred in a drive array;

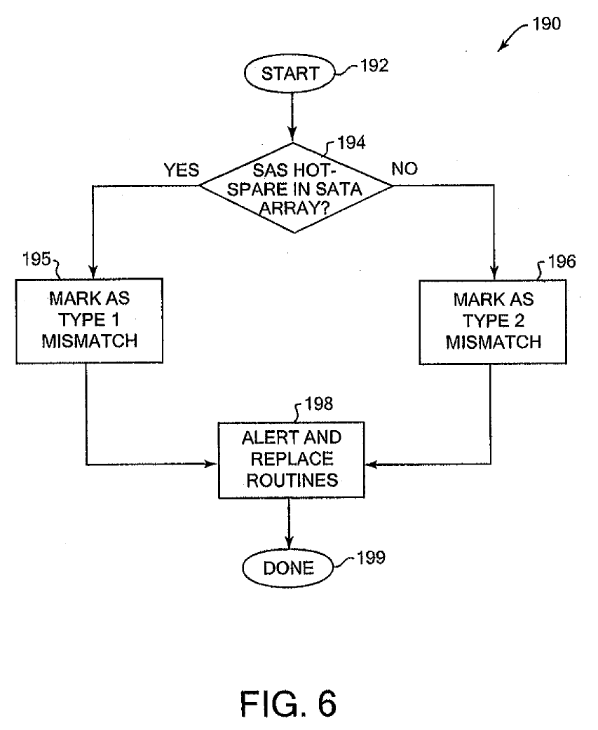

FIG. 6 is a flow diagram illustrating a method of the present invention which implements emergency hotspare management routines when a drive array has been assigned an emergency hotspare; and

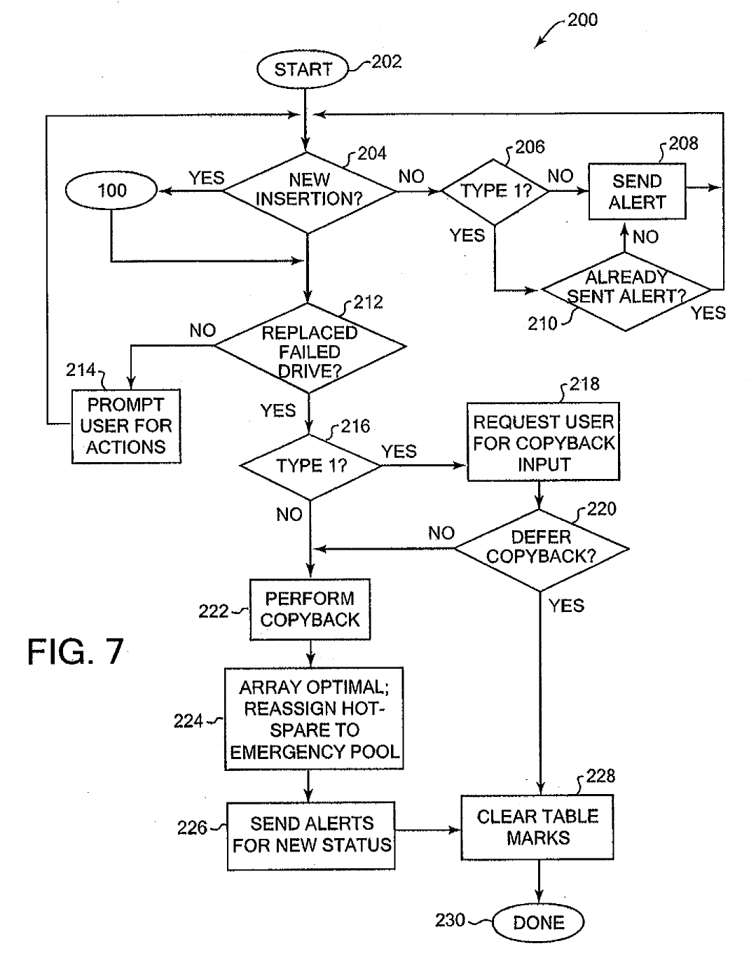

FIG. 7 is a flow diagram illustrating a method of the present invention for providing emergency hotspare alert and drive replacement management for a disk array.

### DETAILED DESCRIPTION

The present invention relates to data storage systems for computers, and more particularly to backup data storage disk drives in a disk array system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular systems provided in particular implementations. However, one of ordinary skill in the art will readily recognize that this method and system will operate effectively in other implementations. For example, the system implementations usable with the present invention can take a number of different forms. The present invention will also be described in the context of particular methods having certain steps. However, the method and system operate effectively for other methods having different and/or additional steps not inconsistent with the present invention.

To more particularly describe the features of the present invention, please refer to FIGS. 1-6 in conjunction with the discussion below.

FIG. 1 is a block diagram illustrating a system 10 suitable for use with the present invention. System 10 includes one or more computer systems 12, an interface 14, a disk array system (shown as a RAID system 16), and a management application 18.

Each computer system 12 is a system that is using the RAID system 16 for data storage. Computer system 12 can be any suitable computer system, server, or electronic device. For example, the computer system 12 can be a mainframe computer, desktop computer, workstation, portable computer, or electronic device (cell phone, personal digital assistant, audio player, game device, etc.). In some embodiments, multiple computer systems 12 can be connected to the other components of system 10 using a computer network.

Each computer system 12 can include one or more microprocessors to execute program code and control basic operations of the computer system 12. The computer system can include other standard components, such as memory (e.g., random access memory (RAM) and/or read only memory (ROM)) and peripheral interface devices that perform various functions. For example, network adapters can be included to enable the computer system to communicate with other computer systems or devices through intervening private or public networks. An operating system can run on the computer system 12 and is implemented by the microprocessor and other components of the computer system 12.

Each computer system 12 is connected to a host interface 14, which implements one or more standard communication protocols. For example, in the embodiments described herein, SAS and SATA are two different peripheral standards which are supported by the host interface 14 and allow the computer systems 14 to communicate with other devices connected to the host interface 14 using those standards. For example, a SAS host interface/controller 14 can support both SAS drives and SATA drives. In other embodiments, other standards or types of communication protocols can be used with the present invention, e.g., FibreChannel Protocol. In the embodiment of FIG. 1, one host interface 14 is shown connecting to multiple computer systems 12; in other embodiments, each computer system 12 can be connected to its own host interface 14 (e.g., the storage enclosure can be connected directly to a host or through a switch\hub attachment to allow for multiple hosts to share a port).

A RAID system 16 is connected to the host interface 14. The computer systems 12 can read from and write data to the storage systems of the RAID system 16 via the host interface 14. In typical embodiments, the computer systems 12 can access logical storage partitions configured by a RAID controller 22 of the RAID system 16 and do not access or configure the underlying physical configuration of the RAID system 16 RAID system 16 can be, for example, a housing including multiple slots or bays, each slot holding a disk drive of the RAID system. Other RAID configurations can also be used, with RAID disk drives in computer housings or other locations. Other disk array system types, other than RAIDs, can also be used with the present invention; the embodiments herein, however, are described with reference to RAID devices.

The RAID system 16 includes RAID controller 22 which controls the input and output from the RAID system and interfaces with the computer systems 12. The controller 22 controls the operation of the data disks, parity disks, and hotspare disks of the RAID system. The controller 22 can be hardware-implemented in the RAID housing, in a connected device or computer system, or other configuration. Alternatively, the controller 22 can be implemented partially or completely as software running on a connected device or computer system.

RAID system 16 includes a number of disk drives 24 used for storing digital data. These drives are typically connected in one or more arrays, where the disks of an array combine their resources to appear as one or more logical drives to a user of a computer system 12. In the embodiment of the present invention, two or more types of drives are included in the RAID system, where the “types” refer to different technology types. For example, two different types include SAS drives and SATA disk drives (SATA being a type of Integrated Drive Electronics (IDE) drive). Such types are described in greater detail below with respect to FIG. 2A.

A software management application 18 can run on the RAID controller 22 or a device or computer connected to the RAID controller 22 or RAID system 16 (e.g., on a computer or workstation connected directly to the RAID system 16 or remotely over a network). The management application 18 allows a user (e.g., manager) to see the physical configuration of the RAID system 16 and can be accessed by the user to configure the operation of the RAID system 16, including defining logical partition sizes and arrays, locating RAID controllers on a connected network, defining storage parameters, and configuring other characteristics. In addition, the management application 18 can be used to provide notifications and messages to the user, such as the alerts and warnings described below in the methods of FIGS. 3-7. For example, such messages can be displayed on a display screen and/or output via another output device, such as audio devices, tactile devices, etc. For example, the notifications and alerts can be email messages or other types of electronic messages sent to particular devices accessed by designated users.

FIG. 2A is a diagrammatic illustration of a disk array system 30 (e.g., RAID system) including two disk drive arrays and two hotspares. With respect to the present invention, at least two disk arrays in the disk array system 16 have different types, i.e., the system provides mixed technology drive arrays. In the embodiments described herein, these two different types are SAS and SATA. SAS devices and controllers can support SAS drives and SATA disks, while SAS drives are not compatible on a SATA bus. SAS disk drives are typically a higher cost, better-performing drive technology type (faster, more reliable, etc.) as compared with SATA drives, which are more inexpensive, slower, and less reliable.

Thus, SAS drives are often used to store high speed data, such as operations in a database, and small-record, randomly-accessed data. SATA drives often are larger capacity storage devices having a slower spindle speed, and are often used for storing near-line data and large-record, sequentially-accessed data. In other embodiments, other drive technology types can be used; the present invention provides additional advantages when one type has lower performance than the other type(s).

In the described example, a SAS array 32 is shown as a 3+1 array, indicating three SAS drives for data storage and one SAS drive to store parity data used for reconstructing data from a failed drive in the array. In addition, a SAS hotspare drive 34 is provided, which is available to replace a failed drive of the array 32. A failed drive can be “rebuilt” on the hotspare 34 by reconstructing the data on the failed drive using the parity data on the fourth SAS drive of the array 32.

A SATA array 36 is similarly provided, where a 3+1 array includes three SATA drives for data storage and one SATA drive to store parity data. In addition, a SATA hotspare drive 38 is available to replace a failed drive of the array 36, similar to the SAS hotspare 34. However, if one of the SAS drives fails and the associated hotspare is unavailable for some reason (e.g., that hotspare has replaced a different failed drive), then according to the present invention the SATA hotspare can be used as a hotspare for the array with the failed drive. This is illustrated in greater detail with respect to FIG. 2B.

FIG. 2B is a diagrammatic illustration of a disk array system 50 which includes three arrays of disk drives. Two of the arrays 52 and 54 are SAS types of drives, and one of the arrays 56 is a SATA type. One SAS hotspare 58 and one SATA hotspare 60 are also provided. In the example shown, one SAS drive 62 has failed first, which causes the RAID controller 22 to assign the SAS hotspare 58 as a replacement drive for the failed drive 62. However, if the failed drive 62 is not replaced with a new drive by the user, the hotspare 58 will continue to be used in place of the failed drive. A second SAS drive 64 then may fail within the time span in which the failed drive was not replaced by a new drive. In a normal RAID system, the SATA drive could not be used as a hotspare for the second failed drive 64, due to performance differences between different types of drives.

However, in the present invention, the SATA hotspare can be used as a SAS replacement. The SATA hotspare thus acts as a “universal” or “global” hotspare. However, it is also considered an “emergency” hotspare due to the need for the user to replace the failed drive as soon as possible due to potential performance problems when using a different drive types in the same array, especially when the hotspare disk performs more poorly than the array for which it is being used. Thus, in the present invention, the condition of using a hotspare for a unlike disk array is an emergency hotspare condition, or “compromised optimal” operating condition, as opposed to the optimal condition where all drives in an array are of the same type. Any logical drive based at least partially on a disk array with an emergency hotspare condition is also considered as operating under a compromised optimal condition. The present invention includes techniques for recognizing the compromised optimal condition and easing the potential problems when using different drive technology types in this situation, as described in greater detail with respect to FIGS. 3-7. When a replacement drive is provided by the user, the data on the hotspare is copied back to the replacement drive, and when all failed drives have been so replaced, the system is returned to its normal optimal operating condition.

The situation described above can occur in a smaller configuration having fewer drives, where the user typically has enough time to replace a failed drive with a replacement drive and restore the system to its normal operating condition before another drive fails. However, the situation can also occur a larger configuration, where more disks increase the likelihood of a second failure in a shorter time span. This increases the need for more versatile hotspares, as provided by the present invention.

FIG. 2C is a diagrammatic illustration of a disk array system 70 which includes three arrays of drives. In this embodiment, two of the arrays 72 and 74 are a SAS type, and one of the arrays 76 is a SATA type. One SATA hotspare 78 is provided for the entire system. According to the present invention, the SATA hotspare 78 can be used as a universal emergency hotspare to replace any failed drive of the system, of either type.

This embodiment illustrates the versatility that the present invention provides. A situation may exist where a user may not have enough drives available when assembling a system to have more than one hotspare drive. For example, the RAID controller 22 may only have 10 drives available in the physical housing of the RAID system, and the user has configured the system to have three RAID 5 arrays and at least one hotspare. Since the three arrays require nine drives, that leaves only one drive to use as the hotspare. Thus the universal use of the hotspare as provided by the present invention allows the use of a single hotspare and thus for the system requirements to be fulfilled, even with a low number of drives. This ability to use less hotspares also can save space if space for disk drives is limited. In addition, the present invention allows a less expensive drive to be used as a hotspare, e.g., using a SATA drive as a universal hotspare is less expensive than if a SAS hotspare drive were required.

The present invention leverages the availability of disk drives for hot sparing by utilizing a method for the controller 22 to implement universal hotspares, and to maximize the protection of the data when using such hotspares. This is described in greater detail with respect to FIGS. 3-7.

FIG. 3 is a flow diagram illustrating a method 100 of the present invention for detecting drives and drive types in a disk drive array system. This method can be implemented at various points of disk array system operation, such as after a new drive has been inserted in the system, or when a different system condition occurs. The method 100 can be implemented by the controller 22 or other system or device connected to the RAID system 16.

Method 100, and the other methods described herein, can be implemented by program instructions or code, which can be stored by a computer readable medium. The medium can be an electronic, magnetic, optical, electromagnetic, infrared, or semiconductor medium or a propagation medium, including a semiconductor or solid state memory, magnetic tape, a removable computer diskette, a random access memory (RAM), a read-only memory (ROM), a rigid magnetic disk and an optical disk (CD-ROM, DVD, etc.). Alternatively, the method 100 (or any of the other methods described herein) can be implemented in hardware (logic gates, etc.), or in a combination of hardware and software.

It should be noted that the specific embodiment described herein uses particular technologies and standards, such as RAID, SAS, and SATA, and assumes that a drive array will be a type of either SAS or SATA. In other embodiments, other and/or additional drive array and technology standards can be used. For example, a lower-performing drive could be used as an emergency for other types of higher performing devices, such as a SATA drive for a FibreChannel drive. Herein, lower performance generally indicates less reliability or slower random access than other types of higher performing drives.

The method begins at 102, and in step 104, a discovery process is performed. For example, any insertion or removal of a drive to or from a RAID system will typically cause the discovery process to be initiated. The discovery process finds connected disk drives and disk arrays connected to a controller 22 and the types of drives in any discovered RAID systems, such as SAS or SATA drives. Such a process is well-known; for example, the Serial Management Protocol (SMP), part of the SAS standard, provides a discovery process, e.g., for SAS initiators and expanders.

In step 106, after a drive has been discovered in step 104, the process checks if the discovered drive device is an SAS device If not, then it is assumed to be a SATA device (in the described embodiment), and the process continues to step 108, in which the process checks whether the detected SATA drive is a replacement drive that has replaced a previous drive (e.g., a drive that failed), or a new drive, newly inserted into the disk array system and which does not specifically replace any other drive (and thus can add to the storage capacity of the system). The new or replacement status of a drive can be determined, for example, by examining the PHY address of the disk and correlating this address to a drive slot; a replacement drive will have the same drive slot as a failed drive (e.g., a RAID expander (which allows more drives to be connected to a RAID system) can store the discovered PHY address using the SMP to generate alerts on device insertion and removal. This allows the system to keep a running count of the number of changes to the subsystem, and to know, via the Expander PHY address, the slot of a connected device). If it is a replacement drive, then the process continues to step 110 in which an entry corresponding to the drive in a drive configuration table or SATA table is marked to indicate the drive is a replacement, e.g. by changing a flag or writing some other designator. The process then continues to step 118, described below. The SATA table can be a table or other organizational structure in memory accessible to the controller 22 which tracks the SATA drives currently provided in the system. If it is not a replacement drive (i.e., is a new drive), the process continues to step 112, in which the drive is listed in a new entry in the SATA table. The process then continues to step 118, described below.

If the discovered device is a SAS device in step 106, then the process continues to step 114, in which the process checks whether the detected drive is a replacement drive or a new drive. If it is a replacement, then the process continues to step 116 in which an entry corresponding to the drive in the drive configuration table or an SAS table is marked to indicate the drive is a replacement. The SAS table can track the current SAS drives of the system. The process then continues to step 118, described below. If it is a new drive, the process continues from step 114 to step 117, in which the drive is listed in a new entry in the SAS table. The process then continues to step 118, described below.

In step 118, the process checks whether discovery of drives is complete. If not, the process returns to step 104 to perform additional discovery. Otherwise, the discovery process is complete at 119.

FIG. 4 is a flow diagram illustrating a method 120 of the present invention for categorizing array and hotspare drives in a disk drive array system. Method 120 creates categories for hotspares, so that the rest of the routines can determine how to handle alerts and copyback operations during an emergency hotspare condition. This method can be performed in an initialization of a disk array system, e.g., after an initial discovery process of FIG. 3, or after a drive has been newly inserted into the system, as described with reference to FIG. 7. Parts of this method can also be performed at other times during disk array system operation. (e.g., hotspare creation can be performed after a device insertion and array creation).

The process starts at 121, and in step 122, the process creates arrays of the detected drives. This is typically performed according to criteria provided by the user (e.g., operator or administrator) of the RAID system, who may want a specific number of drives per array, and/or a specific number of hotspares. For example, the user may specify that there are to be three RAID 5 arrays and at least one hotspare, as in the example of FIG. 2C. The criteria can also be supplied or supplemented from other sources, such as standardized configurations or configurations already used on other RAIDs in the system. The process will create each array so that only SAS drives are in the array, or only SATA drives are in the array, to maintain higher performance and reliability. In later iterations of this step, after the arrays have already been created, and this step can be skipped.

In next step 124, the process selects one of the drives of the disk array system, and in step 126, the process checks whether the selected drive is a hotspare drive. If the selected drive is not a hotspare, then it is a drive that is a member of a disk array (data drive or parity drive, for example), or it is an unused drive. Thus the method continues to step 128 to mark the drive as an array member in the device configuration table for the drive array system, or equivalent data structure (or mark the drive as unused, if that is the case). The process then continues to step 140, described below.

If the selected drive is a hotspare as checked in step 126, then the process continues to step 130, where the process checks whether the hotspare is a dedicated drive. A “dedicated” drive is one that has been designated (by the user, or as a predetermined or default setting) to be used as a hotspare only for a like type of drive, not for a different drive type. This can be an option provided to the user, for example, if the user wishes to dedicate one or more hotspares for standard use with same-type drives. If the hotspare is dedicated, the process continues to step 132, in which the drive is marked as dedicated in the device configuration table (or no designation is made, and so defaults to a dedicated drive). The process then continues to step 140, described below.

If the hotspare drive is not dedicated as checked in step 130, then in step 134 the process checks whether the hotspare has an entry in the SAS device table. This would indicate that the hotspare is an SAS drive. If so, the process continues to step 136, where the SAS drive is marked as an “emergency SAS hotspare” by the controller 22. An emergency hotspare is one that can be used for a different drive type, if necessary. Since an SAS drive has better performance and reliability than a SATA drive, there are fewer potential problems when using a SAS drive as a hotspare for a SATA array, and an SAS hotspare can generally operate as a emergency hotspare with no long-term performance concerns for a SATA array; there is less urgency to replace a failed drive which the SAS hotspare is operating in place of. The process then continues to step 140, described below.

If the selected drive is not in the SAS device table as checked in step 134, then the selected drive is a SATA drive (in the described embodiment). The process continues to step 138, where the SATA drive is marked in the device configuration table as an “emergency SATA hotspare” by the controller 22. The process then continues to step 140, described below. Since the SATA hotspare will compromise the performance of a SAS array, its continued operation is considered more of an emergency and a short-term measure, and it is intended to be replaced with a drive of the proper type as quickly as possible.. The later-described methods of FIGS. 5-7 can distinguish an actual hotspare situation appropriately.

In step 140, the process checks whether the processing is complete, i.e., whether there are any more drives to select and examine in step 124. If so, the process returns to step 124 to select another drive of the system. Once processing is complete, the method is complete at 142.

FIG. 5 is a flow diagram illustrating a method 150 of the present invention for determining whether hotspares are available after a disk drive failure has occurred in a drive array. The method begins at 152, and in step 154, a drive fails during stable operation of the disk array system. In step 156, the process checks whether a hotspare is available to take over for the failed drive. If not, the disk array is degraded as indicated in step 158, and the controller 22 provides warnings to the user, e.g. via the management application 18. As explained above, degraded mode has poorer performance than normal operation, and is very vulnerable since an additional failure cannot be accommodated and data would be lost. The warnings thus include an indication that degraded mode has been entered and that the operator should replace the failed drive as soon as possible. In next step 160, degraded array management routines are performed by the system, as is well known to those of skill in the art, and the process is complete at 161.

If a hotspare is available in step 156, then the process continues to step 162, in which a check is made as to whether the failed drive is in an SAS disk array. If so, the process continues to step 164, in which the process checks whether there is a SAS hotspare available. In general, a dedicated SAS hotspare, if available, should be assigned to an array with a failed drive before an emergency SAS hotspare is assigned, since hotspares of the same drive type as the failed drive are more efficiently allocated in that way. If a SAS hotspare is available, then in step 166 the SAS hotspare is assigned for the SAS array to take over the operation of the failed drive, which is a standard hotspare condition. In addition, if the assigned SAS hotspare is an emergency SAS hotspare, its “emergency” designation is removed from the device configuration table. In step 168, standard management routines, including standard replace routines, are performed to rebuild the failed drive's data on the hotspare and set up the hotspare to operate as (in place of) the failed drive. This configuration is stable over a long operating period, and so no extra warnings to the user are required. The process is thus complete at 170.

If a SAS hotspare is not available in step 164, then there is a SATA hotspare available, and the process checks in step 171 whether all available SATA hotspares are dedicated, i.e., only usable for SATA arrays, which cannot be used in the present situation. If so, then no emergency SATA hotspares are available for the present situation, and the process continues to step 158 to a degraded mode and to provide warnings to the user, as described above. If, however, an available SATA drive is not dedicated, then the process continues to step 172, in which an emergency SATA hotspare is assigned for the SAS array with the failed drive. In next step 174, the process performs emergency hotspare management routines, which are detailed with respect to FIG. 6. The current process is thus complete at 170.

If the failed drive is not a SAS device as checked in step 162, then the failed drive is a SATA device (in the described embodiment using SAS and SATA devices). The process continues to step 176 to check whether a SATA hotspare is available. As above, a dedicated SATA hotspare, if available, should be assigned to an array with a failed drive before an emergency SATA hotspare is assigned. If a SATA hotspare is not available, then a SAS hotspare is available, and the process checks in step 164 whether all available SAS hotspares are dedicated. If so, then no emergency SAS hotspares are available for the present situation, and the process continues to step 158 to a degraded mode and to provide warnings to the user. If, however, an available SAS drive is not dedicated, then the process continues to step 178, in which an emergency SAS hotspare is assigned for the SATA array with the failed drive. In next step 180, the process performs emergency hotspare management routines, which are detailed with respect to FIG. 6. The current process is thus complete at 170.

Even though the SAS hotspare has higher performance and reliability than a SATA hotspare, this is still considered an emergency hotspare condition with different drive types and the emergency hotspare routines are performed in the described embodiment. However, it is less of a compromised condition than when a SATA hotspare is assigned to a SAS array, and these different conditions are distinguished in the methods of FIGS. 6 and 7.

If a SATA hotspare is available as checked in step 176, the process continues to step 182, in which the SATA hotspare is assigned to the SATA array, which is a standard hotspare condition. In addition, if the assigned SATA hotspare is an emergency SATA hotspare, its “emergency” designation is removed from the device configuration table. In next step 168, standard management routines are performed to rebuild the failed drive's data on the hotspare and set up the hotspare to operate in place of the failed drive. The process is then complete at 170.

FIG. 6 is a flow diagram illustrating a method 190 of the present invention which implements emergency hotspare management routines when a drive array has been assigned an emergency hotspare. The method 190 can be initiated in response to various different conditions in the system 10. In one case, the method 190 is implemented as step 174 or step 180 in the process 150 of FIG. 5, in response to a drive failing in the drive array system and an emergency hotspare of one type being assigned to a disk array of different type.

The method begins at 192, and in step 194, the process checks whether the selected hotspare drive (which, in the case of method 150, is the emergency hotspare assigned to a different drive array type, creating an emergency hotspare condition) is an emergency SAS hotspare assigned to a SATA array. If so, then the process continues to step 195, in which the emergency hotspare condition is categorized as a “Type 1” mismatch by the controller 22. For example, the hotspare can be marked for Type 1 status in the drive configuration table or other appropriate storage. The process then continues to step 198.

In the described embodiment, if the hotspare drive is not a SAS hotspare for a SATA array, then it is a SATA hotspare for a SAS array, and the process continues from step 194 to step 196. In this step, the emergency hotspare condition is categorized as a “Type 2” mismatch by the controller 22, indicating that an emergency SATA hotspare is assigned to a SAS array. For example, the hotspare can be marked for Type 2 status in the drive configuration table or other appropriate storage. The process then continues to step 198. The Type 2 condition is more critical than the Type 1 condition due to the lower performance/reliability of the hotspare in the Type 2 condition, as explained above.

In step 198, the process implements alert and replace routines which check the drive array conditions and alert the user of the emergency hotspare conditions. This process is described in greater detail below with respect to FIG. 7. The process is then complete at 199. In other embodiments, the method 190 need not be provided as a separate method or routine; instead, the steps 195 and 196 can be performed in place of the emergency routine steps 174 and 180 of FIG. 5, respectively.

In the described embodiment, the Type 1 and Type 2 categories indicate a SAS hotspare for an SATA array and a SATA hotspare for a SAS array, respectively. Other embodiments can use different designations or messages to indicate these conditions, or equivalent conditions, e.g., when a lower-performance type of drive is used as a hotspare for a higher-performance drive array type, and vice-versa.

FIG. 7 is a flow diagram illustrating a method 200 of the present invention for providing emergency hotspare alert and drive replacement management for a disk array, as initiated in the method 190 of FIG. 6. This method is being performed during an emergency hotspare condition (compromised optimal condition) in a drive array system such as RAID system 16, in which a hotspare of one type of drive is being used for a drive array of a different type. Method 200 includes alert and replace routines that continually check the state of the RAID system 16 for a change in drive conditions and provide alerts to users. In the described embodiment, the emergency hotspare condition has been designated as Type 1 or Type 2 in the method 190 of FIG. 6, and such designation is provided to method 200.

The method begins at 202, and in step 204, the process checks whether a new drive has been inserted in the disk array system. If not, then at step 206 the process checks whether a Type 1 or Type 2 condition exists. If Type 2, the process continues to step 208 to provide an alert to the user about the emergency hotspare condition. The alert can warn the user that the failed drive should be replaced with a drive having the same type as the failed drive (or sufficiently similar to allow long-term stable, optimal performance). The user can also be provided with other information, such as the type of condition (Type 1 or Type 2). Such alerts can be similar to the alerts provided in step 158 of FIG. 5, e.g., displayed or output messages, email messages, etc. The process then returns to step 204 to check for a new insertion. Thus, in a Type 2 condition, the user will get continuous alerts until a new disk is inserted, reflecting the fact that the condition is unreliable due to a lower-performing drive being used for a higher-performing disk array. Alternatively, the alerts can be provided based on any predetermined criteria, such as a periodic alert sent every predetermined amount of time, or an increasing alert frequency the longer the emergency hotspare condition exists and/or based on other conditions.

If the condition is determined as a Type 1 condition in step 206, then in step 210 the process checks whether an alert has already been sent to the user. If not, the alert is sent in step 208 as described above. If an alert has already been sent, then the process returns to step 204 to check for drive insertion. Thus, for the less critical Type 1 condition, less alerts are sent to the user, since this is a generally stable condition. In other embodiments, additional alerts can also be sent for Type 1 conditions periodically or based on other conditions.

If there has been a new drive inserted as checked in step 204, the process continues to the start of the discovery process 100, as described above with reference to FIG. 3. The method 100 determines the type of drive and the lists the drive in the proper table indicating its type and replacement status.

After the process 100 of FIG. 3, the process 200 continues to step 212, to check whether there is a replacement drive for the failed drive of the disk array system. This can be determined, for example, by checking the appropriate drive table to determine if the slot of the failed drive now has a drive marked as a replacement. Such a replacement drive may have been the newly inserted drive detected in step 204, if such a new drive has been inserted, where the replacement status was updated in the discovery process 100 of FIG. 3. Alternatively, a different drive in the RAID system 16 may have been designated as a replacement drive after user actions input via the management application 18.

If there is no replacement for the failed drive, then at step 210 the process prompts the user for actions with respect to the emergency hotspare condition. Such actions can include using a newly-inserted drive as the replacement for the failed drive, or asking the user to insert a new drive as the replacement drive. The process then returns to step 204 to check for a newly-inserted drive.

If a replacement for the failed drive has been detected by step 212, then the process continues to step 216, in which the process checks whether the emergency condition is a Type 1 mismatch or not. If so, this indicates an emergency SAS hotspare used for a SATA array (i.e., a higher performance type drive used as hotspare for a lower-performance type drive array), and step 218 is performed, in which the user is alerted and requested for copyback input. This input would indicate the user's choice as to whether he or she wants the replacement drive to immediately be built with the data from the hotspare, in a copyback process. Since the Type 1 emergency condition is not critical, the user can be so prompted and the copyback delayed, if desired.

In step 220, the process checks whether the copyback process has been deferred to a later time, e.g., based on any input the user has provided after the request of step 218, default settings, or some other reason as determined by the system. In some embodiments, if the user does not respond to the request of step 220 (e.g., within a predetermined time period), then the copyback process is assumed to have been deferred, while in other embodiments the copyback process is assumed to take place (assuming all other systems conditions are appropriate). If the copyback has been deferred, the process continues to step 228, described below. If the copyback has not been deferred, then the copyback process is performed in step 222, described below.

If the emergency condition is not Type 1 as determined in step 216, then it is a Type 2 condition, indicating an emergency SATA hotspare used for a SAS array (i.e., a lower performance type drive used as hotspare for a higher-performance type drive array). This is a much more critical situation requiring immediate attention. Thus, the process continues directly to step 222 to perform the copyback process, without prompting or waiting for user input.

In step 222, the copyback process copies the data from the hotspare to the replacement drive, as is well known to those of skill in the art. Once the copyback process is complete, then in step 224, the array is at its optimal state with the replacement drive, and the hotspare is reassigned to the emergency hotspare pool, where it is available for use upon another failure of a drive in the RAID system, in any type of disk array. In step 226, alerts are sent for the new status, indicating to the user that the disk array system is in optimal operating condition with respect to the drive operability. This alert also notifies the user that it is now safe to perform other disk operations since the copyback process is over. In step 228, the marks in the drive configuration table (or other appropriate storage) which relate to the Type l or Type 2 status of the hotspare drive (as set in FIG. 6) are cleared to reflect the current status of the hotspare as available. The process is then complete at 230. In some embodiments, the process 100 of FIG. 3 can then be initiated to discover any new or replacement drives.

The present invention allows unlike drive types to be used as hotspares for each other. This can provide a user with more flexibility and less expense, since he or she need provide fewer hotspare drives, even if different drive types are used in the drive array system. This allows more drives to be used for data than in previous systems having unlike drive types. In addition, the present invention allows more hotspares to be available for either type of disk array in a system, since a hotspare need not be dedicated to only one type of disk array. This allows a more robust system less prone to failures, since more hotspare drives are available for use.

Since the mixing of unlike drives may cause compromised performance, the present invention can promote the quick remedying of the compromised condition. Various alerts, prompts, and copyback functions of the present invention can ensure that an emergency hotspare is not left in service any longer than absolutely necessary and is not forgotten by the user until the hotspare condition itself becomes a problem.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A disk array system comprising:
one or more disk arrays, the disk arrays each including two or more disk drives;
a spare disk drive; and
a controller operative to assign the spare disk drive to a particular one of the disk arrays having a type different than a type of the spare disk drive in response to a failure of a disk drive of the particular disk array, such that the spare disk drive stores data from and operates in place of the failed disk drive.

2. The disk array system of claim 1 wherein the disk arrays are a first type and the disk arrays of the first type each include two or more disk drives of the first type, and further comprising one or more disk arrays of a second type, the disk arrays of the second type each including two or more disk drives of the second type, wherein the spare disk drive is a hotspare disk drive of one of the first and second types.

3. The disk array system of claim 2 wherein the first type of disk drive provides better performance than the second type of disk drive.

4. The disk array system of claim 3 wherein the first disk drive type is SAS and the second disk drive type is SATA.

5. The disk array system of claim 1 wherein while the spare disk drive is assigned to a disk array having a different type than the spare disk drive, compromised performance of the disk array system results.

6. The disk array system of claim 2 wherein the first type of disk drive is better performing than the second type of disk drive, and wherein the hotspare disk drive is of the second type and the particular disk array is of the first type.

7. The disk array system of claim 1 wherein the controller is operative to alert a user of the disk array system to a condition of the disk array system in response to the spare disk drive being assigned to the particular disk array.

8. The disk array system of claim 1 wherein the controller is operative to repeatedly alert the user of the disk array system to a compromised condition of the disk array system in response to the spare disk drive being assigned to the particular disk array, the user being alerted until the failed disk drive has been replaced with an operating disk drive.

9. The disk array system of claim 8 wherein the alert is provided to the user more often if the spare disk drive is a lower performing disk drive than the particular disk array, and less often if the spare disk drive is a better performing disk drive than the particular disk array.

10. The disk array system of claim 1 wherein the controller is operative to determine whether a newly-inserted disk drive is a replacement drive for the failed disk drive in response to a new disk drive being connected to the disk array system,

11. The disk array system of claim 10 wherein the controller determines whether the new disk drive is a replacement drive by comparing the disk drive slot of the new disk drive to the disk drive slot of the failed disk drive.

12. The disk array system of claim 1 wherein the controller is operative to initiate the copying of data stored on the spare disk drive to the replacement disk drive to return the disk array system to its original state provided before the drive failure, in response to a replacement disk drive being connected to the disk array system.

13. The disk array system of claim 12 wherein the controller determines if compromised performance of the disk array system results from the spare disk drive being assigned to the particular disk array, and if the compromised performance is determined to result, the data is copied to the replacement disk drive automatically.

14. The disk array system of claim 13 wherein if the compromised performance is determined not to result, the controller requests the user for input before the data is copied to the replacement disk drive.

15. A method for utilizing a backup disk drive in a disk array system, the method comprising:
detecting a failure of a disk drive in a disk array of the disk array system; and
assigning a spare disk drive to the disk array having the failed disk drive, wherein the spare disk drive is of a different type than the disk array, and wherein the spare disk drive stores data from and operates in place of the failed disk drive.

16. The method of claim 15 wherein the disk array system includes one or more first disk arrays of a first type and one or more second disk arrays of a second type, each first disk array including two or more disk drives of the first type, and each second disk array two or more disk drives of the second type.

17. The method of claim 15 further comprising alerting a user of the disk array system to a compromised condition of the disk array system in response to the spare disk drive being assigned to the disk array having a different type.

18. The method of claim 15 further comprising repeatedly alerting a user of the disk array system to a compromised condition of the disk array system in response to the spare disk drive being assigned to the disk array, the user being alerted until the failed disk drive has been replaced with an operating disk drive.

19. The method of claim 15 further comprising categorizing a condition of the disk array system as more urgent or less urgent for replacement of the failed disk drive with a functional disk drive, based on the degree of compromised performance of the disk array system resulting from the spare disk drive being assigned to the disk array.

20. The method of claim 15 wherein the spare disk drive is a hotspare disk drive, and further comprising copying the data stored on the hotspare disk drive to a replacement disk drive to return the disk array system to its original state provided before the drive failure.

21. The method of claim 20 wherein the copying is performed in response to the replacement disk drive being connected to the disk array system.

22. The method of claim 20 further comprising checking whether compromised performance of the disk array system results from the hotspare disk drive being assigned to the particular disk array.

23. The method of claim 22 wherein if the compromised performance is determined to result, the data is copied to the replacement disk drive automatically.

24. The method of claim 22 wherein if the compromised performance is determined not to result, the controller requests the user for input before the data is copied to the replacement disk drive.

25. The method of claim 15 further comprising determining whether a newly-inserted disk drive is a replacement drive for the failed disk drive, in response to the new disk drive being connected to the disk array system.

26. The method of claim 25 wherein alerts are provided to the user while the spare disk drive is assigned to the disk array having a different type, and wherein the alerts are intensified if the newly-inserted disk drive is not a replacement drive for the failed disk drive.

27. A computer program product comprising a computer readable medium including program instructions to be implemented by a computer and for utilizing a spare disk drive in a disk array system, the program instructions for:
detecting a failure of a disk drive in a particular disk array of the disk array system, the disk array system including one or more first disk arrays of a first type and one or more second disk arrays of a second type, each first disk array including two or more disk drives of the first type, and each second disk array including two or more disk drives of the second type; and
assigning a hotspare disk drive to the particular disk array having the failed disk drive, wherein the hotspare disk drive is of a different type than the particular disk array, and wherein the hotspare disk drive stores data from and operates in place of the failed disk drive.
